(19) United States
(12) Patent Application Publication
(10) Pub. No.: US 2016/0178479 A1
(43) Pub. Date: Jun. 23, 2016

(54) DYNAMIC DIAGNOSTIC INDICATOR GENERATION

(71) Applicant: Hand Held Products, Inc., Fort Mill, SC (US)

(72) Inventor: Stanley Goldsmith, Chalotte, NC (US)

(21) Appl. No.: 14/573,022

(22) Filed: Dec. 17, 2014

(51) Int. Cl. G01M 15/02

(52) U.S. Cl. CPC G01M 15/02

(57) ABSTRACT

An example method for analyzing an operating characteristic of a machine is described. Information is accessed, which has been extracted from the machine in relation to the operating characteristic thereof. The accessed information is transmitted wirelessly to a receptive code pattern generator. Upon reception, the transmitted information is decoded. A code pattern is generated, which corresponds to the decoded information. The generated code pattern is read and interpreted. The interpreted code pattern describes the machine operating characteristic, which is analyzed in real time based on the interpretation.

### TECHNOLOGY

The present invention relates generally to presenting information. An example embodiment of the present invention relates to generating code patterns dynamically for presenting information in real time, which may be relevant to diagnostic analyses performed over engines or other machinery.

### BACKGROUND

Engine analyzers and other diagnostic equipment are coupled electrically to automotive, marine, aircraft and industrial engines or other machinery for exchange of data signals. Typically, flexible cables are used for interconnecting the engine analyzers to the engines.

From an origin at the engine analyzer, the cables comprise a number of insulated electrical conductors running its length to a connector device at its far end. The connector device couples with a complimentary connection port on the engine under test.

The signals exchanged between the engine analyzer and the engine under test allow retrieval of various parameters, which relate to operating characteristics of the engine under test. These data may then be evaluated to ascertain the condition of the engine and/or diagnose problems therewith.

Machines such as contemporary automotive, aircraft and other engines comprise microcontrollers and other electronic components, which may intercommunicate via a controller area network (CAN) bus. Engine analyzers may connect communicatively with the engine components via its CAN bus.

Connecting the electrical cable for testing an engine typically involves some ancillary tasks. While for the most part routine, labor associated with such tasks is not trivial. Automotive diagnosticians for example may seek engine connections within, beneath or behind dashboards or bulkheads.

Further, significant variation in the location and type of connectors between different makes, models, series, etc. is not unusual. Once the engine connector is located, the technician must then couple a complimentary analyzer cable connector electromechanically therewith. The exchange of data signals may then commence.

However, frequent use in industrial environments like automotive repair facilities subject cables and their connectors to wear and tear. Cables may fray and its electrical insulation thus breach, which exposes its conductor. Wires within the cable break or wear. Damage to its connector opens the conductive path of the data signals.

Internal wire breaks, connector damage and insulation failures prevent use of the engine analyzer until the cable is replaced. While the cable replacement cost itself is not trivial, that cost may be exceeded by revenue losses associated with the resulting downtime of the analyzer.

Engine analyzers and conductors of the connecting cables may have operating voltages or static potential that differs in relation to the engine. The potential differences may cause arcing when making or breaking the interconnections. The arcing may damage electronics or pose burn, ignition or shock hazards.

Wireless approaches such as Bluetooth have been developed, which allow readouts from the CAN bus by engine analyzers and computers (e.g., PCs). Notwithstanding the availability of Bluetooth enabled CAN bus readout however, cables are still used with such approaches.

Therefore, a need exists for reducing labor used to interface engine analyzers with various engines. A need also exists for deterring cable damage and for reducing resulting analyzer downtime and costs associated with either or both. Further, a need exists for preventing arcs in making and breaking connections between analyzer cables and engines.

The approaches described in this background section may, but not necessarily have been conceived or pursued previously. Unless otherwise indicated expressly to the contrary, it should not be assumed that any of the discussions above include material that may be reasonably alleged to relate to any so-called prior art merely by such discussion. Nor should any issues discussed in relation to this background be assumed to have been recognized in any alleged prior art merely based on any such discussion above.

### SUMMARY

Accordingly, example embodiments of the present invention in one aspect embrace reduced labor and costs, relative to using cable interfaces between engine analyzers and engines under test therewith. Example embodiments obviate such cable interfaces and thus, cable wear and associated analyzer downtime and related costs. Moreover, the possibility of arcing and its associated problems is thus eliminated.

An example embodiment of the present invention is described in relation to a method for analyzing an operating characteristic of an engine or other machine. The example method comprises accessing a source of information related to the engine/machine operating characteristic. The engine/machine operating characteristic related information is extracted from the accessed information source. The extracted information is transmitted wirelessly, e.g., via an RF medium to a receptive code pattern generator. The transmitted information is decoded upon a reception thereof and a code pattern is generated that corresponds to the decoded information. The generated code pattern is then read and interpreted, which may include a retransmission thereof, e.g., via optical scanning or a second RF transmission. The interpreted code pattern relates to the engine/machine operating characteristic. The engine/machine operating characteristic is analyzed in real time based on the interpretation.

The machine may comprise an engine. The engine or other machine (engine/machine) may comprise a component of a mobile or stationary industrial installation. The engine/machine may comprise a component of an automobile or other vehicle, an aircraft, a boat or other marine craft, locomotive, or of other vehicles or installations.

The source of the engine/machine operating characteristic related information comprises a control area network (CAN) bus and a component operable for electrically coupling with the CAN bus. The accessing step may thus relate to accessing the CAN bus and exchanging signals therewith via the electrical coupling component.

In an example embodiment, transmitting the information wirelessly step relates to a RF transmission. Bluetooth, ISM or other UHF bands may be used.

In an example embodiment, the code pattern comprises a 2D pattern such as a PDF417 barcode pattern or a QR matrix code pattern. The code pattern encodes data corresponding to the engine/machine operating condition related information. The code pattern may then be read (e.g., retransmitted) and the data encoded therewith decoded and interpreted. The interpretation of the code pattern data allows analysis of the engine in real time, e.g., relative to the generation of the corresponding code pattern.

The foregoing illustrative summary, as well as other examples described in relation to embodiments of the present invention, and the manner in which the same are accomplished, are further explained within the more detailed description and its accompanying drawings, which are set forth below.

### BRIEF DESCRIPTION OF THE DRAWINGS

FIG. 1 schematically depicts an example technology ecosystem, according to an embodiment of the present invention;

FIG. 2 schematically depicts an example system, according to an embodiment of the present invention;

FIG. 3 depicts example computer and network platforms, with which an embodiment of the invention may be implemented; and

FIG. 4 depicts a flowchart for an example process, according to an embodiment of the present invention.

### DESCRIPTION OF EXAMPLE EMBODIMENTS

An embodiment of the present invention embraces reduced labor and costs, relative to using cable interfaces between engine analyzers and engines under test therewith. Example embodiments obviate such cable interfaces and thus, cable wear and associated analyzer downtime and related costs. Moreover, the possibility of arcing and its associated problems is thus eliminated.

An example embodiment of the present invention is described in relation to a method for analyzing an operating characteristic of an engine or other machine. The example method comprises accessing a source of information related to the engine/machine operating characteristic. The engine/machine operating characteristic related information is extracted from the accessed information source. The extracted information is transmitted wirelessly, e.g., via an RF medium to a receptive code pattern generator. The transmitted information is decoded upon a reception thereof and a code pattern is generated that corresponds to the decoded information. The generated code pattern is then read and interpreted, which may include a retransmission thereof, e.g., via optical scanning or a second RF transmission. The interpreted code pattern relates to the engine/machine operating characteristic. The engine/machine operating characteristic is analyzed in real time based on the interpretation.

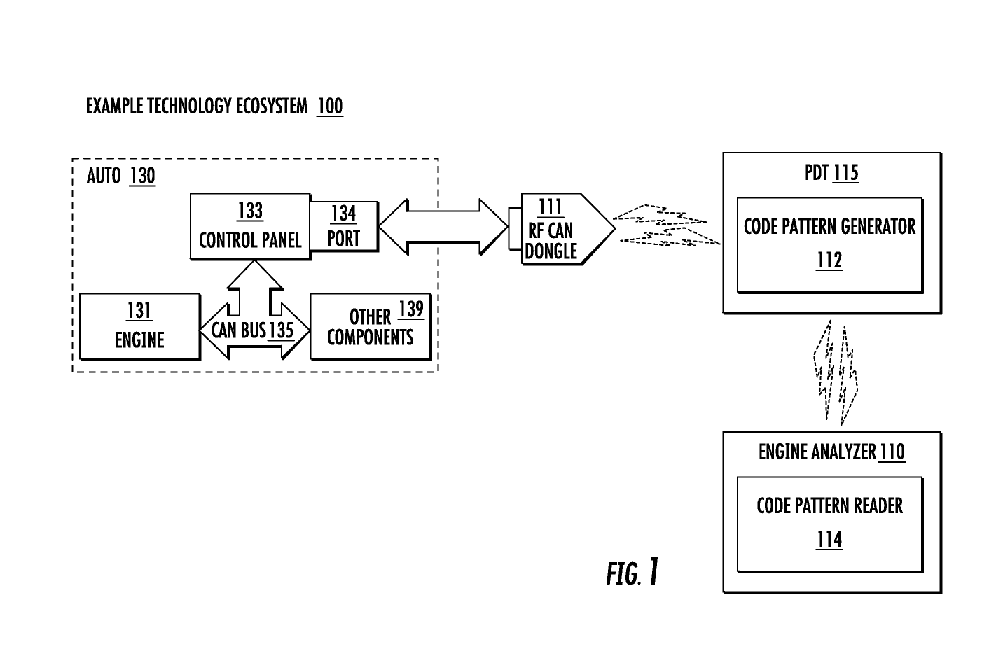

FIG. 1 depicts an example technology ecosystem 100, according to an embodiment of the present invention. The technology ecosystem 100 comprises a portable data terminal (PDT) 115 and an engine analyzer 110. An example embodiment is implemented within the technology ecosystem 100 in which an operating characteristic of a machine such as an engine is analyzed in real time.

By way of illustration, FIG. 1 depicts an example automotive vehicle 130, which has an engine 131. Within the technology ecosystem 100, an operating condition may be analyzed, which characterizes the engine 131. For example, the vehicle 130 may be in for maintenance, diagnostics, experimentation or repairs in a vehicle service setting. Other machines may also be analyzed however, which are represented herein with reference to the example engine 131.

For example, the engine 131 may comprise a component of another type of vehicle (truck, bus, etc.) or of an aircraft, a boat or other marine craft or a locomotive or in a mobile or stationary industrial installation such as a power plant or factory. The engine 131 depicted for example in FIG. 1 may also represent another machine (e.g., electric generators and/or motors, air conditioners and/or refrigerators, industrial machinery) disposed in such settings and/or also comprising components with functionality not dissimilar to that represented in FIG. 1 by the CAN bus 135.

Within the automobile 130, a control area network (CAN) bus 135 interconnects the engine 131 (and multiple components thereof), other components (e.g., air conditioners, drive and steering chains, brakes, transmissions, etc.) with a control panel 133. Control panel 133 may be disposed as a component of, or in proximity to a dashboard or similar area for localizing controls used to operate the automobile 130 or other installation.

The machine operating characteristic related information comprises data, which at a time point at which it is accessed, corresponds uniquely to multiple (a plurality of) physical parameters associated descriptively with one or more mechanical properties of the engine 131 and its multiple various components.

The physical parameters may be descriptive, diagnostic and/or dispositive of factors related to the condition of the engine/machine, multiple various mechanical and other components thereof, wear, heating, cooling, pressures, temperatures, electrical attributes of microcontrollers and other electronic devices. Such devices may operate as components of the engine/machine. The physical parameters may also reflect chemical states or conditions relating to oxygenation, oxidation (e.g., formation of ‘NOₓ’ oxides of nitrogen), combustion, exhaust and pollution production, corrosion, etc.

In an example embodiment, a wireless interface 111 may be coupled removably to a complimentary port 134, and thus interconnected therewith communicatively to the CAN bus 135. The wireless interface 111 is operable to access the CAN bus 135. The port 134 comprises an access point to contact the CAN bus 135 and thus, a source for access to the information related to the machine operating characteristic. The wireless interface 111 is also operable to encode and transmit the accessed information via a radio frequency (RF) data network.

The wireless interface 111 may be implemented with a RF dongle device (or another type or style of device having a functionality not dissimilar thereto), which is configured to interface effectively with the CAN bus 135 for an exchange of signals therewith. The dongle device is removably installed via the complimentary port 134 when the analyzer 110 is ready to analyze the engine 131.

An example embodiment may also be implemented however in which the wireless interface 111 comprises a component of (or otherwise in permanent proximity to) the control panel 133. In this case, the port 134 shown in FIG. 1 represents an internal, fixed or more-or-less permanent interconnection associated with the control panel 133 and/or the wireless interface 111, which remains the access point or source of the machine operating condition related data.

In an example embodiment, the wireless interface 111 transmits the information over a radio frequency (RF) channel. The RF channel may span an ultrahigh frequency (UHF) message spectrum. The UHF spectrum may comprise the industrial, scientific and medical (ISM) frequency band, which is at or around a range of electromagnetic wavelengths spanning 2.4 Gigahertz (GHz) to 2.485 GHz, inclusive. Thus, the RF channel may operate using Bluetooth or similar functionality.

An example embodiment may be implemented in which an application installed and operable on the PDT 115 queries the wireless interface device 111 and/or the CAN bus 135 therewith to access (e.g., read, extract) the data related to the condition information relevant to the engine 131. The application (or other software associated therewith) may then control a generation of a code pattern corresponding thereto.

The PDT 115 is operable to receive and decode the wirelessly transmitted machine condition related information. The PDT 115 comprises a code patter generator 112. The code pattern generator 112 is operable to generate a code pattern corresponding uniquely to the decoded information. The code pattern may comprise two dimensions (2D). The 2D code pattern may comprise a barcode.

An example embodiment may be implemented in which the barcode is represented with a PDF417 pattern, which conforms to a portable document file (PDF) format comprising four bars and spaces and a length comprising 17 units (which “PDF417” abbreviates). The barcode pattern may also be represented with a quick response (QR) code pattern or another matrix code pattern.

The generated code pattern is then transmitted wirelessly over a second wireless network, which may be operable over an optical medium or another RF subnet. The optical medium may be operable over infrared and/or visible portions of the electromagnetic spectrum. The RF subnet may comprise Wi-Fi related or Bluetooth related functionality.

An example embodiment may be implemented in which a second PDT or computer is operable to effectively scan the code pattern and retransmit the data thereof to the engine analyzer 110. In an example embodiment, the engine analyzer 110 is operable to receive the wirelessly transmitted code pattern directly.

For example, an optically operable barcode scanner or QR scanner may scan the code pattern. A code pattern reading component 114 associated with the engine analyzer 110 is operable to read and decode the received code pattern.

The engine analyzer 110 is further operable to interpret the decoded code pattern data and analyze the engine 131 based on the interpretation. The engine analyzer 110 is operable to evaluate the engine 131 in relation to the machine condition related information based on the interpretation of the code pattern. An example embodiment of the present invention thus relates to a system, which is operable for analyzing an operating characteristic of an engine or other machine (engine/machine).

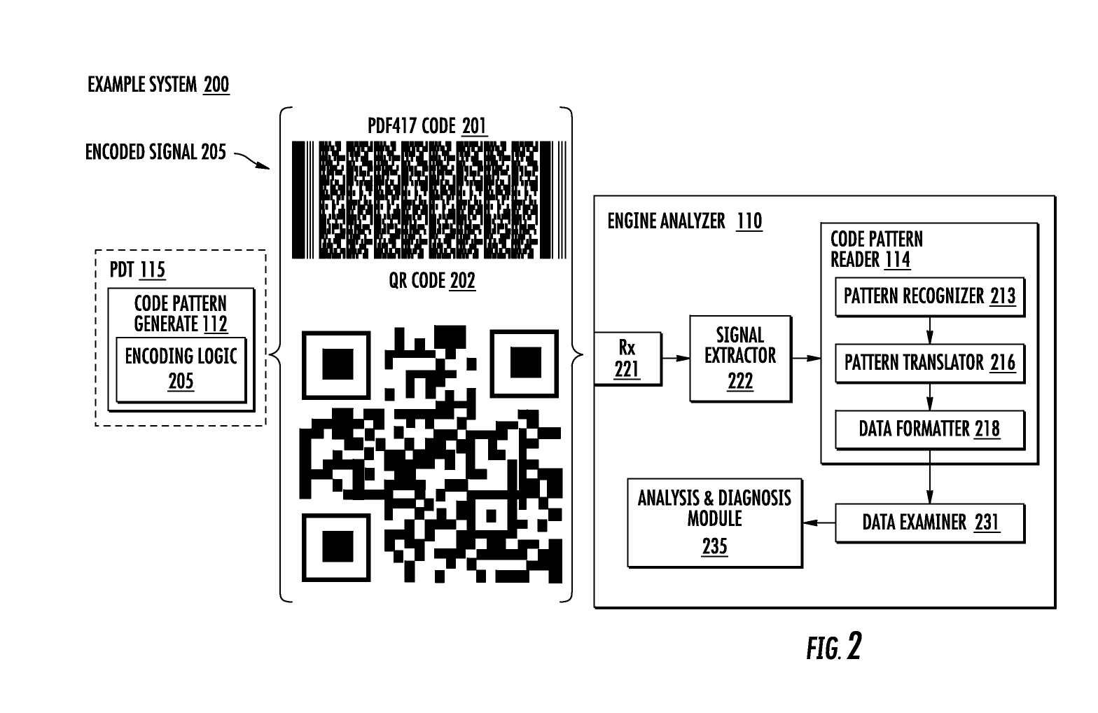

FIG. 2 depicts an example system 200 operable for analyzing an operating characteristic of an engine/machine, according to an embodiment of the present invention. The code pattern generator 112 of the PDT 115 comprises encoding logic 205.

The encoding logic 205 is operable to generate a PDF417 barcode pattern 201 and/or a QR code pattern 202, which may each correspond uniquely to the machine condition related data (e.g., extracted from CAN bus 135; FIG. 1). The PDT 115 is further operable to transmit the encoded PDF417 barcode 201 and/or the encoded QR code 202 wirelessly as data content over an infrared (IR) or other optical or RF (e.g., Wi-Fi, Bluetooth) signal 205.

The wireless signal 205 is read by an optical or RF receiver (Rx) 221 component of the engine analyzer 110. A decoder 222 is operable to decode the signal 205 and extract therefrom the code pattern, which is read with a code pattern reader 114.

A pattern recognizer 213 of the code pattern reader 114 is operable to recognize the type, style, size and other characteristics of the extracted code pattern. A translator 216 is operable to translate the data represented graphically in the code pattern, which may then be formatted for analysis in a formatter 218.

The formatted data is subjected to an examination 231. Based on the examined data, a diagnostic functionality 235 is operable to evaluate and report on the machine condition related information. Analysis of the machine operating condition may be based on the reported evaluation.

An example embodiment of the present invention thus relates to a system, which is operable for analyzing an operating characteristic of an engine/machine. The system comprises a data source and wireless transmitter component operable to access information extracted from the engine/machine in relation to the operating characteristic thereof and to encode and transmit the accessed information via a RF data network. The system also comprises a code pattern generator component operable to receive and decode the transmitted information and to generate therewith a corresponding code pattern. Further, the system comprises an analyzer component operable to interpret the generated code pattern and to analyze the engine/machine operating characteristic in real time based on the code pattern interpretation.

Another example embodiment of the present invention relates to a communication network, which is operable for analyzing an operating characteristic of an engine/machine. The communication network comprises a first wireless data subnet component operable over a first RF range and over which information related to the machine operating characteristic is exchanged between a RF transmitter and a RF receiver. The RF receiver is associated with a code pattern generator operable to generate a 2D code pattern corresponding to the machine operating characteristic related information. The communication network also comprises at least a second wireless data subnet component, operable over at least one of a second RF range, or over an infrared or other optical wavelength range. The generated 2D code pattern is exchanged over the at least second wireless subnet with an analyzer, which is operable to interpret the generated 2D code pattern and to determine the machine operating characteristic in real time based on the 2D code pattern interpretation.

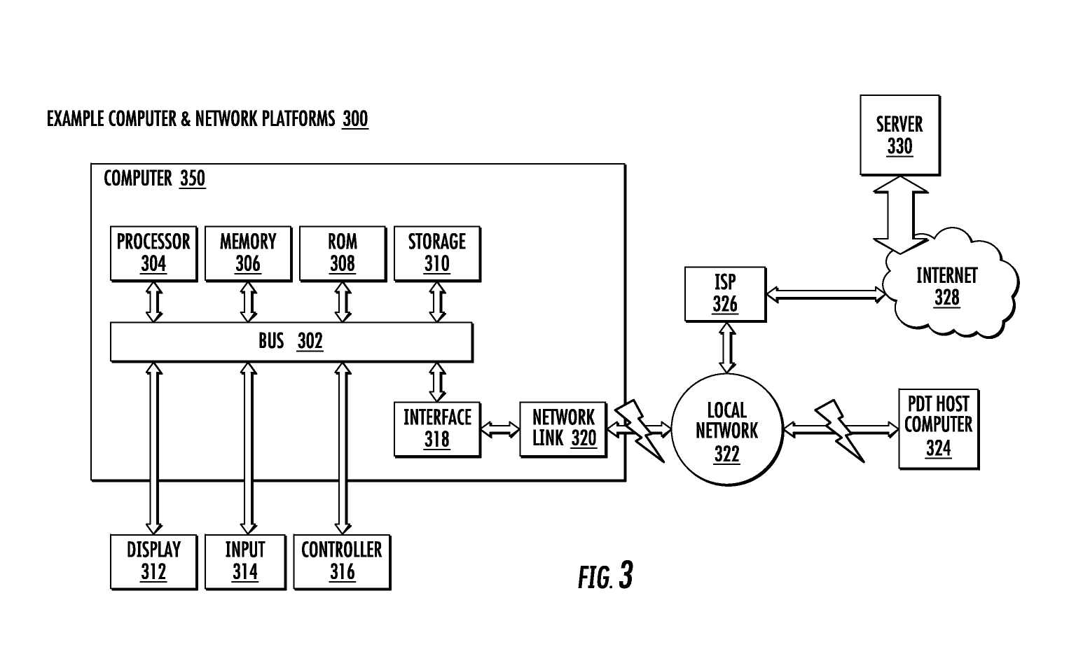

FIG. 3 depicts example computer and network platforms 300, with which an embodiment of the invention may be implemented. For example, the PDT 115 and/or the engine analyzer 110 may each comprise a computer and/or exchange data via networks, which may be represented at least in relation to some aspects thereof with reference to FIG. 3

FIG. 3 depicts an example computer system platform 350, with which an embodiment of the present invention may be implemented. Computer system 350 includes a bus 302 or other communication mechanism for communicating information, and a processor 304 coupled with bus 302 for processing information. Computer system 350 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304.

Computer system 350 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions. Processor 304 may perform one or more digital signal processing (DSP) functions. Additionally or alternatively, DSP functions may be performed by another processor or entity (represented herein with processor 304).

Computer system 350 may be coupled via bus 302 to a display 312, such as a liquid crystal display (LCD), cathode ray tube (CRT), plasma display or the like, for displaying information to a computer user. In some PDT applications, LCDs or “thin” or “cold cathode” CRTs may be used with some regularity.

An input device 314, including alphanumeric (and/or other) symbols and other keys, is coupled to bus 302 for communicating information and command selections to processor 304. Another type of user input device is cursor control 316, such as haptic-enabled “touch-screen” GUI displays or a mouse, a trackball, or cursor direction keys for communicating direction information and command selections to processor 304 and for controlling cursor movement on display 312.

Such input devices typically have two degrees of freedom in two axes, a first axis (e.g., x) and a second axis (e.g., y), which allows the device to specify positions in a plane. Some phones with simpler keyboards may implement this or a similar feature haptically using a touch-screen GUI display and/or with a set of directionally active “arrow” keys.

Embodiments of the invention relate to the use of computer system 350 for generating code patterns dynamically in relation to engine/machine operating condition related information, such as the QR patterns and barcodes, and other embodiments described herein. An embodiment of the present invention relates to the use of computer system 350 to compute analyses, evaluations and/or diagnosis relating to engine/machine operating conditions, as described herein. According to an embodiment of the invention, 2D code patterns are generated and interpreted. This feature is provided, controlled, enabled or allowed with computer system 350 functioning in response to processor 304 executing one or more sequences of one or more instructions contained in main memory 306.

Such instructions may be read into main memory 306 from another computer-readable medium, such as storage device 310. Execution of the sequences of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement the invention. Thus, embodiments of the invention are not limited to any specific combination of hardware, circuitry, firmware and/or software.

The terms “computer-readable medium” and/or “computer-readable storage medium” as used herein may refer to any medium that participates in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and other conductors and fiber optics, including the wires (or other conductors or optics) that comprise bus 302. Transmission media can also take the form of acoustic (e.g., sound) or electromagnetic (e.g., light) waves, such as those generated during radio wave and infrared and other optical data communications.

Common forms of computer-readable media include, for example, a floppy disk, a flexible disk, hard disk, magnetic tape, or any other magnetic medium, a CD-ROM, any other optical medium, punch cards, paper tape, any other legacy or other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem.

A modem local to computer system 300 can receive the data on the telephone line and use an infrared transmitter to convert the data to an infrared signal. An infrared detector coupled to bus 302 can receive the data carried in the infrared signal and place the data on bus 302. Bus 302 carries the data to main memory 306, from which processor 304 retrieves and executes the instructions. The instructions received by main memory 306 may optionally be stored on storage device 310 either before or after execution by processor 304.

Computer system 350 also includes a communication interface 318 coupled to bus 302. Communication interface 318 provides a two-way data communication coupling to a network link 320 that is connected to a local network 322. For example, communication interface 318 may comprise a legacy integrated services digital network (ISDN) card or a digital subscriber line (DSL), cable or other modem to provide a data communication connection to a corresponding type of telephone line. As another example, communication interface 318 may comprise a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) (or telephone switching company) 326. In an embodiment, local network 322 may comprise a communication medium with which a user's telephone functions. ISP 326 in turn provides data communication services through the worldwide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 350, are exemplary forms of carrier waves transporting the information.

Computer system 350 can send messages and receive data, including program code, through the network(s), network link 320 and communication interface 318.

In the Internet example, a server 330 might transmit a requested code for an application program through Internet 328, ISP 326, local network 322 and communication interface 318. In an embodiment of the invention, one such downloaded application provides for dynamic generation and interpretation of 2D code patterns in relation to analyzing, diagnosing and/or evaluating engine/machine operating condition related information.

The received code may be executed by processor 304 as it is received, and/or stored in storage device 310, or other non-volatile storage for later execution. In this manner, computer system 300 may obtain application code in the form of a carrier wave.

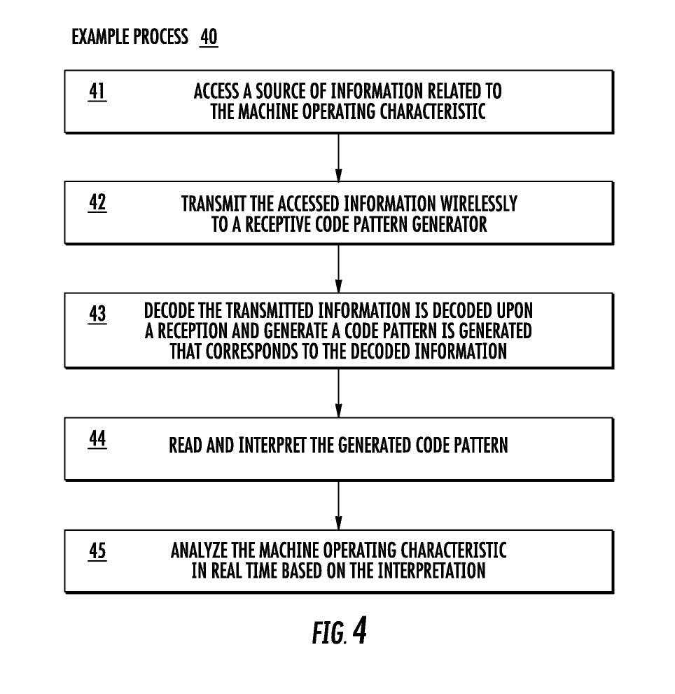

FIG. 4 depicts a flowchart for an example process 40, according to an embodiment of the present invention. Process 400 relates to a method for analyzing an operating characteristic of an engine/machine.

In step 41, a source of information related to the machine operating characteristic is accessed. The machine operating characteristic related information is extracted from the accessed information source.

In step 42, the extracted information is transmitted wirelessly to a receptive code pattern generator.

In step 43, the transmitted information is decoded upon a reception thereof and a code pattern is generated that corresponds to the decoded information.

In step 44, the generated code pattern is read and interpreted. Step 44 may comprise retransmitting the information relating to the machine/engine operating condition. For example, the code pattern may be read by optical (e.g., IR) scanning thereof, or its retransmission via a second RF channel (e.g., Wi-Fi or Bluetooth) to a code reader, with which it is interpreted. The interpreted code pattern relates to the machine operating characteristic.

In step 45, the machine operating characteristic is analyzed in real time based on the interpretation.

An example embodiment of the present invention is thus described in relation to a method for analyzing an operating characteristic of an engine or other machine. The example method comprises accessing a source of information related to the engine/machine operating characteristic. The engine/machine operating characteristic related information is extracted from the accessed information source. The extracted information is transmitted wirelessly, e.g., via an RF medium to a receptive code pattern generator. The transmitted information is decoded upon a reception thereof and a code pattern is generated that corresponds to the decoded information. The generated code pattern is then read and interpreted, which may include a retransmission thereof, e.g., via optical scanning or a second RF transmission. The interpreted code pattern relates to the engine/machine operating characteristic. The engine/machine operating characteristic is analyzed in real time based on the interpretation.

Thus, example embodiments of the present invention have been described, which may effectively reduce labor and costs, relative to using cable interfaces between engine analyzers and engines or other machines under test therewith. Example embodiments obviate such cable interfaces and thus, cable wear and associated analyzer downtime and related costs. Moreover, the possibility of arcing and its associated problems is thus eliminated.

An example embodiment of the present invention has been described in relation to analyzing an operating characteristic of an engine or other machine. A source of information is accessed in relation to the engine/machine operating characteristic. The engine/machine operating characteristic related information is extracted from the accessed information source. The extracted information is transmitted wirelessly to a receptive code pattern generator. The transmitted information is decoded upon a reception thereof and a code pattern is generated that corresponds to the decoded information and read and interpreted. The interpreted code pattern relates to the engine/machine operating characteristic. The engine/machine operating characteristic is interpreted, e.g., upon retransmission optically or via RF, and analyzed in real time based on the interpretation.

The machine may comprise an engine. The engine or other machine (engine/machine) may comprise a component of a mobile or stationary industrial installation. The engine/machine may comprise a component of an automobile or other vehicle, an aircraft, a boat or other marine craft, locomotive, or of other vehicles or installations.

The source of the engine/machine operating characteristic related information comprises a CAN bus and a component operable for electrically coupling with the CAN bus. The accessing step may thus relate to accessing the CAN bus and exchanging signals therewith via the electrical coupling component.

In an example embodiment, transmitting the information wirelessly step relates to a RF transmission. Bluetooth, ISM or other UHF bands may be used.

In an example embodiment, the code pattern comprises a 2D pattern such as a PDF417 barcode pattern or a QR matrix code pattern. The code pattern encodes data corresponding to the engine/machine operating condition related information. The code pattern may then be read (e.g., retransmitted) and the data encoded therewith decoded and interpreted. The interpretation of the code pattern data allows analysis of the engine in real time, e.g., relative to the generation of the corresponding code pattern.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,526;
U.S. Pat. No. 8,798,367; U.S. Pat. No. 8,807,431;
U.S. Pat. No. 8,807,432; U.S. Pat. No. 8,820,630;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2011/0202554;
U.S. Patent Application Publication No. 2012/0111946;
U.S. Patent Application Publication No. 2012/0138685;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0056285;
U.S. Patent Application Publication No. 2013/0070322;
U.S. Patent Application Publication No. 2013/0075168;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0200158;
U.S. Patent Application Publication No. 2013/0256418;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0278425;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306730;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0341399;
U.S. Patent Application Publication No. 2013/0342717;
U.S. Patent Application Publication No. 2014/0001267;
U.S. Patent Application Publication No. 2014/0002828;
U.S. Patent Application Publication No. 2014/0008430;
U.S. Patent Application Publication No. 2014/0008439;
U.S. Patent Application Publication No. 2014/0025584;
U.S. Patent Application Publication No. 2014/0027518;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061305;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0075846;
U.S. Patent Application Publication No. 2014/0076974;
U.S. Patent Application Publication No. 2014/0078341;
U.S. Patent Application Publication No. 2014/0078342;
U.S. Patent Application Publication No. 2014/0078345;
U.S. Patent Application Publication No. 2014/0084068;
U.S. Patent Application Publication No. 2014/0097249;
U.S. Patent Application Publication No. 2014/0098792;
U.S. Patent Application Publication No. 2014/0100774;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0108682;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0160329;
U.S. Patent Application Publication No. 2014/0166755;
U.S. Patent Application Publication No. 2014/0166757;
U.S. Patent Application Publication No. 2014/0166759;
U.S. Patent Application Publication No. 2014/0166760;
U.S. Patent Application Publication No. 2014/0166761;
U.S. Patent Application Publication No. 2014/0168787;
U.S. Patent Application Publication No. 2014/0175165;
U.S. Patent Application Publication No. 2014/0175169;
U.S. Patent Application Publication No. 2014/0175172;
U.S. Patent Application Publication No. 2014/0175174;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0203087;
U.S. Patent Application Publication No. 2014/0204268;
U.S. Patent Application Publication No. 2014/0214631;
U.S. Patent Application Publication No. 2014/0217166;
U.S. Patent Application Publication No. 2014/0217180;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application No. 29/436,337 for an Electronic Device, filed Nov. 5, 2012 (Fitch et al.);
U.S. patent application Ser. No. 13/771,508 for an Optical Redirection Adapter, filed Feb. 20, 2013 (Anderson);
U.S. patent application Ser. No. 13/852,097 for a System and Method for Capturing and Preserving Vehicle Event Data, filed Mar. 28, 2013 (Barker et al.);
U.S. patent application Ser. No. 13/902,110 for a System and Method for Display of Information Using a Vehicle-Mount Computer, filed May 24, 2013 (Hollifield);
U.S. patent application Ser. No. 13/902,144, for a System and Method for Display of Information Using a Vehicle-Mount Computer, filed May 24, 2013 (Chamberlin);
U.S. patent application Ser. No. 13/902,242 for a System For Providing A Continuous Communication Link With A Symbol Reading Device, filed May 24, 2013 (Smith et al.);
U.S. patent application Ser. No. 13/912,262 for a Method of Error Correction for 3D Imaging Device, filed Jun. 7, 2013 (Jovanovski et al.);
U.S. patent application Ser. No. 13/912,702 for a System and Method for Reading Code Symbols at Long Range Using Source Power Control, filed Jun. 7, 2013 (Xian et al.);
U.S. patent application No. 29/458,405 for an Electronic Device, filed Jun. 19, 2013 (Fitch et al.);
U.S. patent application Ser. No. 13/922,339 for a System and Method for Reading Code Symbols Using a Variable Field of View, filed Jun. 20, 2013 (Xian et al.);
U.S. patent application Ser. No. 13/927,398 for a Code Symbol Reading System Having Adaptive Autofocus, filed Jun. 26, 2013 (Todeschini);
U.S. patent application Ser. No. 13/930,913 for a Mobile Device Having an Improved User Interface for Reading Code Symbols, filed Jun. 28, 2013 (Gelay et al.);
U.S. patent application No. 29/459,620 for an Electronic Device Enclosure, filed Jul. 2, 2013 (London et al.);
U.S. patent application No. 29/459,681 for an Electronic Device Enclosure, filed Jul. 2, 2013 (Chaney et al.);
U.S. patent application Ser. No. 13/933,415 for an Electronic Device Case, filed Jul. 2, 2013 (London et al.);
U.S. patent application No. 29/459,785 for a Scanner and Charging Base, filed Jul. 3, 2013 (Fitch et al.);
U.S. patent application No. 29/459,823 for a Scanner, filed Jul. 3, 2013 (Zhou et al.);
U.S. patent application Ser. No. 13/947,296 for a System and Method for Selectively Reading Code Symbols, filed Jul. 22, 2013 (Rueblinger et al.);
U.S. patent application Ser. No. 13/950,544 for a Code Symbol Reading System Having Adjustable Object Detection, filed Jul. 25, 2013 (Jiang);
U.S. patent application Ser. No. 13/961,408 for a Method for Manufacturing Laser Scanners, filed Aug. 7, 2013 (Saber et al.);
U.S. patent application Ser. No. 14/018,729 for a Method for Operating a Laser Scanner, filed Sep. 5, 2013 (Feng et al.);
U.S. patent application Ser. No. 14/019,616 for a Device Having Light Source to Reduce Surface Pathogens, filed Sep. 6, 2013 (Todeschini);
U.S. patent application Ser. No. 14/023,762 for a Handheld Indicia Reader Having Locking Endcap, filed Sep. 11, 2013 (Gannon);
U.S. patent application Ser. No. 14/035,474 for Augmented-Reality Signature Capture, filed Sep. 24, 2013 (Todeschini);
U.S. patent application No. 29/468,118 for an Electronic Device Case, filed Sep. 26, 2013 (Oberpriller et al.);
U.S. patent application Ser. No. 14/055,234 for Dimensioning System, filed Oct. 16, 2013 (Fletcher);
U.S. patent application Ser. No. 14/053,314 for Indicia Reader, filed Oct. 14, 2013 (Huck);
U.S. patent application Ser. No. 14/065,768 for Hybrid System and Method for Reading Indicia, filed Oct. 29, 2013 (Meier et al.);
U.S. patent application Ser. No. 14/074,746 for Self-Checkout Shopping System, filed Nov. 8, 2013 (Hejl et al.);
U.S. patent application Ser. No. 14/074,787 for Method and System for Configuring Mobile Devices via NFC Technology, filed Nov. 8, 2013 (Smith et al.);
U.S. patent application Ser. No. 14/087,190 for Optimal Range Indicators for Bar Code Validation, filed Nov. 22, 2013 (Hejl);
U.S. patent application Ser. No. 14/094,087 for Method and System for Communicating Information in an Digital Signal, filed Dec. 2, 2013 (Peake et al.);
U.S. patent application Ser. No. 14/101,965 for High Dynamic-Range Indicia Reading System, filed Dec. 10, 2013 (Xian);
U.S. patent application Ser. No. 14/150,393 for Indicia-reader Having Unitary Construction Scanner, filed Jan. 8, 2014 (Colavito et al.);
U.S. patent application Ser. No. 14/154,207 for Laser Barcode Scanner, filed Jan. 14, 2014 (Hou et al.);
U.S. patent application Ser. No. 14/165,980 for System and Method for Measuring Irregular Objects with a Single Camera filed Jan. 28, 2014 (Li et al.);
U.S. patent application Ser. No. 14/166,103 for Indicia Reading Terminal Including Optical Filter filed Jan. 28, 2014 (Lu et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 14/250,923 for Reading Apparatus Having Partial Frame Operating Mode filed Apr. 11, 2014, (Deng et al.);
U.S. patent application Ser. No. 14/257,174 for Imaging Terminal Having Data Compression filed Apr. 21, 2014, (Barber et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/274,858 for Mobile Printer with Optional Battery Accessory filed May 12, 2014 (Marty et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/300,276 for METHOD AND SYSTEM FOR CONSIDERING INFORMATION ABOUT AN EXPECTED RESPONSE WHEN PERFORMING SPEECH RECOGNITION, filed Jun. 10, 2014 (Braho et al.);
U.S. patent application Ser. No. 14/305,153 for INDICIA READING SYSTEM EMPLOYING DIGITAL GAIN CONTROL filed Jun. 16, 2014 (Xian et al.);
U.S. patent application Ser. No. 14/310,226 for AUTOFOCUSING OPTICAL IMAGING DEVICE filed Jun. 20, 2014 (Koziol et al.);
U.S. patent application Ser. No. 14/327,722 for CUSTOMER FACING IMAGING SYSTEMS AND METHODS FOR OBTAINING IMAGES filed Jul. 10, 2014 (Oberpriller et al,);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/329,303 for CELL PHONE READING MODE USING IMAGE TIMER filed Jul. 11, 2014 (Coyle);
U.S. patent application Ser. No. 14/333,588 for SYMBOL READING SYSTEM WITH INTEGRATED SCALE BASE filed Jul. 17, 2014 (Barten);
U.S. patent application Ser. No. 14/334,934 for a SYSTEM AND METHOD FOR INDICIA VERIFICATION, filed Jul. 18, 2014 (Hejl);
U.S. patent application Ser. No. 14/336,188 for METHOD OF AND SYSTEM FOR DETECTING OBJECT WEIGHING INTERFERENCES, Filed Jul. 21, 2014 (Amundsen et al.);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/340,716 for an OPTICAL IMAGER AND METHOD FOR CORRELATING A MEDICATION PACKAGE WITH A PATIENT, filed Jul. 25, 2014 (Ellis);
U.S. patent application Ser. No. 14/342,544 for Imaging Based Barcode Scanner Engine with Multiple Elements Supported on a Common Printed Circuit Board filed Mar. 4, 2014 (Liu et al.);
U.S. patent application Ser. No. 14/345,735 for Optical Indicia Reading Terminal with Combined Illumination filed Mar. 19, 2014 (Ouyang);
U.S. patent application Ser. No. 14/336,188 for METHOD OF AND SYSTEM FOR DETECTING OBJECT WEIGHING INTERFERENCES, Filed Jul. 21, 2014 (Amundsen et al.);
U.S. patent application Ser. No. 14/355,613 for Optical Indicia Reading Terminal with Color Image Sensor filed May 1, 2014 (Lu et al.);
U.S. patent application Ser. No. 14/370,237 for WEB-BASED SCAN-TASK ENABLED SYSTEM AND METHOD OF AND APPARATUS FOR DEVELOPING AND DEPLOYING THE SAME ON A CLIENT-SERVER NETWORK filed Jul. 2, 2014 (Chen et al.);
U.S. patent application Ser. No. 14/370,267 for INDUSTRIAL DESIGN FOR CONSUMER DEVICE BASED SCANNING AND MOBILITY, filed Jul. 2, 2014 (Ma et al.);
U.S. patent application Ser. No. 14/376,472, for an ENCODED INFORMATION READING TERMINAL INCLUDING HTTP SERVER, filed Aug. 4, 2014 (Lu);
U.S. patent application Ser. No. 14/379,057 for METHOD OF USING CAMERA SENSOR INTERFACE TO TRANSFER MULTIPLE CHANNELS OF SCAN DATA USING AN IMAGE FORMAT filed Aug. 15, 2014 (Wang et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/460,387 for APPARATUS FOR DISPLAYING BAR CODES FROM LIGHT EMITTING DISPLAY SURFACES filed Aug. 15, 2014 (Van Horn et al.);
U.S. patent application Ser. No. 14/460,829 for ENCODED INFORMATION READING TERMINAL WITH WIRELESS PATH SELECTON CAPABILITY, filed Aug. 15, 2014 (Wang et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/446,387 for INDICIA READING TERMINAL PROCESSING PLURALITY OF FRAMES OF IMAGE DATA RESPONSIVELY TO TRIGGER SIGNAL ACTIVATION filed Jul. 30, 2014 (Wang et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application No. 29/486,759 for an Imaging Terminal, filed Apr. 2, 2014 (Oberpriller et al.);
U.S. patent application No. 29/492,903 for an INDICIA SCANNER, filed Jun. 4, 2014 (Zhou et al.); and
U.S. patent application No. 29/494,725 for an IN-COUNTER BARCODE SCANNER, filed Jun. 24, 2014 (Oberpriller et al.).

In the specification and/or figures, example embodiments of the invention have been disclosed. Embodiments of the present invention however are not limited to such examples. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

What is claimed is:

1. A method for analyzing an operating characteristic of a machine, the method comprising the steps of:
accessing a source of information, which is extracted from the machine in relation to the operating characteristic thereof;
transmitting the accessed information wirelessly to a receptive code pattern generator;
decoding the transmitted information upon a reception thereof;
generating a code pattern that corresponds to the decoded information;
interpreting the generated code pattern, wherein the interpreted code pattern relates to the machine operating characteristic; and
analyzing the machine operating characteristic in real time based on the interpreting step.

2. The method as described in claim 1, wherein the machine comprises an engine.

3. The method as described in claim 1, wherein the machine comprises a component of at least one of a vehicle or a mobile or stationary industrial installation.

4. The method as described in claim 3, wherein the vehicle comprises at least one of an automotive vehicle, an aircraft, a marine craft, or a locomotive.

5. The method as described in claim 1, wherein the source of the machine operating characteristic related information comprises:
a control area network (CAN) bus; and
a component operable for electrically coupling with the CAN bus,
wherein the accessing step comprises accessing the CAN bus and exchanging signals therewith via the electrical coupling component.

6. The method as described in claim 1, wherein the transmitting wirelessly step relates to a radio frequency (RF) transmission.

7. The method as described in claim 6, wherein the RF transmission relates to one or more of an ultrahigh frequency (UHF) message spectrum; an industrial, scientific and medical (ISM) frequency band; an electromagnetic wavelength range comprising the range of 2.4 Gigahertz (GHz) to 2.485 GHz, inclusive; or a Bluetooth network.

8. The method as described in claim 1, wherein the code pattern comprises a two dimensional (2D) pattern related to at least one of a barcode or a matrix barcode.

9. The method as described in claim 8, wherein the 2D pattern comprises at least one of a PDF417 (portable data file comprising four bars and spaces and a length comprising 17 units) barcode pattern or a quick response (QR) matrix barcode pattern.

10. The method as described in claim 1, wherein the machine operating characteristic related information comprises data, which at a time point of a performance of the accessing step correspond uniquely to a plurality of physical parameters associated descriptively with one or more mechanical properties of the engine.

11. The method as described in claim 1 further comprising the step of retransmitting the generated code pattern to a receptive code pattern reader, wherein the interpreting the generated code pattern step comprises reading the retransmitted code pattern.

12. A system operable for analyzing an operating characteristic of an engine or machine (engine/machine), the system comprising:
a data source and wireless transmitter component operable to access information extracted from the engine/machine in relation to the operating characteristic thereof and to encode and transmit the accessed information via a radio frequency (RF) data network;
a code pattern generator component operable to receive and decode the transmitted information and to generate therewith a corresponding code pattern; and
an analyzer component operable to interpret the generated code pattern and to analyze the engine/machine operating characteristic in real time based on the code pattern interpretation.

13. The system as described in claim 12 wherein the data source and transmitter component is communicatively coupled via a control area network (CAN) bus to a plurality of components of the engine/machine, and wherein the extracted engine/machine operating condition related information is collected from one or more of the engine/machine components via the CAN bus.

14. The system as described in claim 12 wherein the RF data network is operable over one or more of an ultrahigh frequency (UHF) message spectrum; an industrial, scientific and medical (ISM) frequency band; an electromagnetic wavelength range comprising the range of 2.4 Gigahertz (GHz) to 2.485 GHz, inclusive; or a Bluetooth network.

15. The system as described in claim 12 wherein the code pattern comprises a two dimensional (2D) pattern related to a barcode or a matrix barcode.

16. The system as described in claim 15, wherein the 2D pattern comprises at least one of a PDF417 (portable data file comprising four bars and spaces and a length comprising 17 units) bar code or a quick response (QR) matrix bar code.

17. The system as described in claim 12, wherein the machine operating characteristic related information comprises data, which at a time point of a performance of the extracting step correspond uniquely to a plurality of physical parameters associated descriptively with one or more mechanical properties of the engine.

18. The system as described in claim 12 wherein the data source and wireless transmitter component comprises at least one of:
a removable device, which is further operable for establishing a temporary communicative connection with the data source component; or
a device disposed in a permanent communicative connection with the data source component.

19. The system as described in claim 12 wherein the code pattern generator component is further operable to transmit the generated code pattern wirelessly to the analyzer component, and wherein the analyzer component is further operable to receive the generated code pattern wirelessly from the code pattern generator.

20. The system as described in claim 12 wherein the code pattern generator component is disposed with a portable data terminal (PDT).

21. A communication network operable for analyzing an operating characteristic of a machine, the communication network comprising:
a first wireless data subnet component operable over a first radio frequency (RF) range and over which information related to the machine operating characteristic is exchanged between a RF transmitter and a RF receiver, wherein the RF receiver is associated with a code pattern generator operable to generate a two dimensional (2D) code pattern corresponding to the machine operating characteristic related information; and
at least a second wireless data subnet component, operable over at least one of a second RF range, or over an infrared or other optical wavelength range, and over which the generated 2D code pattern is exchanged with an analyzer operable to interpret the generated 2D code pattern and to determine the machine operating characteristic in real time based on the 2D code pattern interpretation.
